(19) United States
(12) Patent Application Publication
(10) Pub. No.: US 2026/0267257 A1
(43) Pub. Date: Sep. 10, 2026

(54) DEVELOPING DEVICE, PROCESS CARTRIDGE, AND IMAGING FORMING APPARATUS

(71) Applicants: Hiroaki KATO, Kyoto (JP); Akihiro KAWASAKI, Kanagawa (JP); Shuichi NAKAGAWA, Osaka (JP); Yutaro KAKU, Kanagawa (JP); Taira OTSUKA, Kanagawa (JP); Yasuhide MATSUNO, Kanagawa (JP)

(72) Inventors: Hiroaki KATO, Kyoto (JP); Akihiro KAWASAKI, Kanagawa (JP); Shuichi NAKAGAWA, Osaka (JP); Yutaro KAKU, Kanagawa (JP); Taira OTSUKA, Kanagawa (JP); Yasuhide MATSUNO, Kanagawa (JP)

(73) Assignee: ETRIA CO., LTD., Yokohama (JP)

(21) Appl. No.: 19/452,594

(22) Filed: Jan. 19, 2026

(30) Foreign Application Priority Data
Mar. 10, 2025 (JP) 2025-037486

(51) Int. Cl. G03G 15/08; G03G 21/18

(52) U.S. Cl. CPC G03G 15/0808; G03G 15/0812; G03G 15/0896; G03G 21/1814; G03G 2215/0869

(57) ABSTRACT

A developing device includes a developer bearer that rotates and bears a developer and a layer thickness regulator that regulates a thickness of the developer on the developer bearer. The developer bearer has an outer circumferential face having a maximum height roughness Rz in an axial direction of the developer bearer, that is greater than 5.5 μm, an arithmetic average roughness Ra in a circumferential direction of the developer bearer, that is smaller than 1.0 μm, and a hardness that is not smaller than 50.

### CROSS-REFERENCE TO RELATED APPLICATION

This patent application is based on and claims priority pursuant to 35 U.S.C. § 119(a) to Japanese Patent Application No. 2025-037486, filed on Mar. 10, 2025, in the Japan Patent Office, the entire disclosure of which is hereby incorporated by reference herein.

### BACKGROUND

### Technical Field

The present disclosure relates to a developing device, a process cartridge, and an image forming apparatus, and more particularly, to a developing device, a process cartridge incorporating the developing device, and an image forming apparatus incorporating the developing device or the process cartridge.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses include a latent image bearer that bears a latent image and a developing device that includes a developer bearer. The latent image bearer and the developer bearer form a developing nip therebetween. The developer bearer supplies a developer onto the latent image bearer, developing the latent image on the latent image bearer.

In order to supply the developer onto the latent image bearer, the developer bearer has a preset value of surface roughness and the like.

### SUMMARY

The present disclosure described herein provides a developing device that includes a developer bearer that rotates and bears a developer and a layer thickness regulator that regulates a thickness of the developer on the developer bearer. The developer bearer has an outer circumferential face having a maximum height roughness Rz in an axial direction of the developer bearer, that is greater than 5.5 μm, an arithmetic average roughness Ra in a circumferential direction of the developer bearer, that is smaller than 1.0 μm, and a hardness that is not smaller than 50.

The present disclosure described herein further provides a process cartridge that includes a latent image bearer that bears a latent image and a developer remaining on the latent image bearer and the developing device described above that reuses the developer.

The present disclosure described herein further provides an image forming apparatus that includes the process cartridge described above and a transfer device that is disposed opposite the process cartridge.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an image forming apparatus according to an embodiment of the present disclosure;

FIG. 2 is a diagram of the image forming apparatus depicted in FIG. 1 in a printing period, illustrating a method for collecting residual toner failed to be transferred onto a sheet and remaining on a photoconductive drum;

FIG. 3 is a diagram of the image forming apparatus depicted in FIG. 1 in an idle period, illustrating a method for collecting the residual toner;

FIG. 4 is a diagram of the image forming apparatus depicted in FIG. 1 in the idle period, illustrating the method for collecting the residual toner;

FIG. 5 is a schematic diagram of a developing device incorporated in the image forming apparatus depicted in FIG. 1;

FIG. 6 is a perspective view of a developing roller according to an embodiment of the present disclosure, that is incorporated in the developing device depicted in FIG. 5;

FIG. 7 is a cross-sectional view of the developing roller depicted in FIG. 6, illustrating a surface of the developing roller in an axial direction thereof;

FIG. 8 is a perspective view of a developing roller that is different from the developing roller depicted in FIG. 6;

FIG. 9 is a partial cross-sectional view of the developing roller depicted in FIG. 8, illustrating a developing nip formed between the developing roller and the photoconductive drum;

FIG. 10 is a cross-sectional view of the developing roller depicted in FIG. 6 that contacts a foreign substance on a surface of the photoconductive drum;

FIG. 11 is a cross-sectional view of the developing roller depicted in FIG. 6 that contacts a regulation blade incorporated in the developing device depicted in FIG. 5; and

FIG. 12 is a cross-sectional view of a developing device according to another embodiment of the present disclosure, that includes a removal roller and is installable in the image forming apparatus depicted in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to drawings, a description is provided of embodiments of the present disclosure. In the drawings, identical reference numerals are assigned to identical elements and equivalents and redundant descriptions of the identical elements and the equivalents are summarized or omitted properly.

A description is provided of a construction of a developing device that supplies toner serving as a developer and an image forming apparatus that incorporates the developing device.

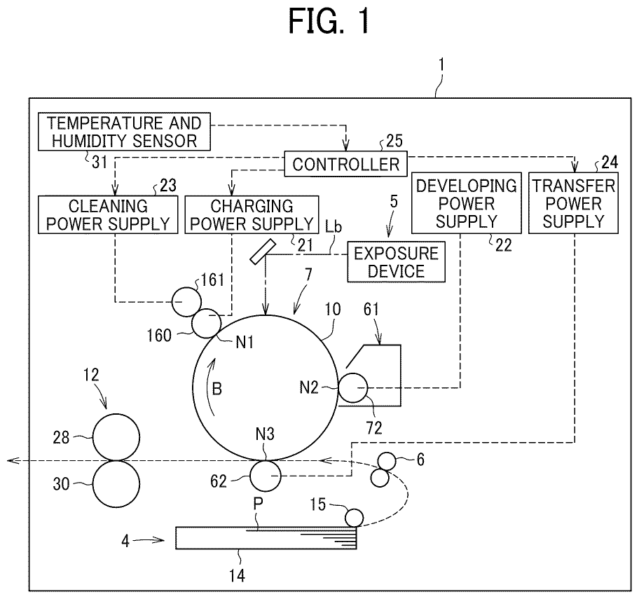

FIG. 1 is a schematic diagram of an image forming apparatus 1 according to an embodiment of the present disclosure.

The image forming apparatus 1 includes a sheet feeder 4, an exposure device 5, a registration roller pair 6, a photoconductive drum 10 serving as a latent image bearer, a charging roller 160, a brush roller 161, a developing device 61, a transfer roller 62 serving as a transfer device, and a fixing device 12. According to the embodiment, the image forming apparatus 1 further includes a process cartridge 7 as a unit into which the photoconductive drum 10, the developing device 61, the charging roller 160, the brush roller 161, a toner cartridge serving as a developer container, and the like are combined. The process cartridge 7 is removably installed in an apparatus body of the image forming apparatus 1. Alternatively, the developing device 61, the photoconductive drum 10, and the like may be separate components, respectively.

The image forming apparatus 1 further includes a charging power supply 21, a developing power supply 22, a cleaning power supply 23, a transfer power supply 24, and a controller 25. The controller 25 controls output of each of the charging power supply 21, the developing power supply 22, the cleaning power supply 23, and the transfer power supply 24. The charging power supply 21 supplies a bias voltage for image formation to the charging roller 160.

The sheet feeder 4 includes a sheet tray 14 and a feed roller 15. The sheet tray 14 loads a plurality of sheets P serving as recording media. The feed roller 15 separates an uppermost sheet P from other sheets P placed on the sheet tray 14 and feeds the uppermost sheet P to the registration roller pair 6, thus feeding the sheets P one by one.

The photoconductive drum 10 is surrounded by the charging roller 160 serving as a charger, the developing device 61 including a developing roller 72, and the transfer roller 62 that are arranged in a rotation direction B of the photoconductive drum 10. The charging roller 160 and the developing roller 72 contact the photoconductive drum 10. The exposure device 5 irradiates a surface of the photoconductive drum 10 with an exposure light beam Lb at an exposure position between the charging roller 160 and the developing roller 72 in the rotation direction B of the photoconductive drum 10. The exposure light beam Lb scans the surface of the photoconductive drum 10.

The image forming apparatus 1 according to the embodiment does not incorporate a cleaner that is disposed downstream from the transfer roller 62 and disposed upstream from the charging roller 160 in the rotation direction B of the photoconductive drum 10. The cleaner contacts the surface of the photoconductive drum 10 and removes residual toner failed to be transferred onto the sheet P and remaining on the surface of the photoconductive drum 10 therefrom. The image forming apparatus 1 that does not incorporate the cleaner is hereinafter referred to as a cleanerless image forming apparatus also. Alternatively, the image forming apparatus 1 may incorporate a cleaner that cleans the charging roller 160 or the like other than the photoconductive drum 10.

As the photoconductive drum 10 starts rotation, the charging power supply 21 applies a charging bias voltage to the charging roller 160, uniformly charging the surface of the photoconductive drum 10 in a charging region N1. The exposure device 5 emits the exposure light beam Lb onto the surface of the photoconductive drum 10 according to image data, discharging an imaging region on the surface of the photoconductive drum 10, that corresponds to the image data. Thus, an electrostatic latent image is formed on the surface of the photoconductive drum 10.

As the photoconductive drum 10 rotates, the electrostatic latent image travels to a developing nip N2 formed between the photoconductive drum 10 and the developing roller 72. The developing power supply 22 applies a developing bias voltage to the developing roller 72. At the developing nip N2, the developing roller 72 supplies negatively charged toner onto the photoconductive drum 10 according to an electric potential difference between an electric potential of an exposed portion on the surface of the photoconductive drum 10 and the developing bias voltage. Thus, the developing roller 72 develops the electrostatic latent image on the photoconductive drum 10 into a toner image.

As the photoconductive drum 10 rotates, the toner image travels to a transfer nip N3 formed between the photoconductive drum 10 and the transfer roller 62. The transfer power supply 24 applies a transfer bias voltage to the transfer roller 62. The transfer roller 62 transfers the toner image onto the sheet P conveyed from the sheet tray 14 to the transfer nip N3 at a time when the toner image meets the sheet P. Thus, the toner image is formed on the sheet P. The image forming apparatus 1 further includes a temperature and humidity sensor 31. The controller 25 determines the transfer bias voltage based on a value detected by the temperature and humidity sensor 31 and a number of sheets P counted by the controller 25 or a travel distance of the transfer roller 62.

The fixing device 12 includes a fixing rotator 28 and a pressure rotator 30 that form a fixing nip therebetween. Each of the fixing rotator 28 and the pressure rotator 30 is a roller, a belt, or the like. As the sheet P bearing the toner image is conveyed through the fixing nip, the fixing rotator 28 and the pressure rotator 30 fix the toner image on a surface of the sheet P under heat and pressure. The sheet Pis ejected onto an output tray disposed on an exterior of the image forming apparatus 1.

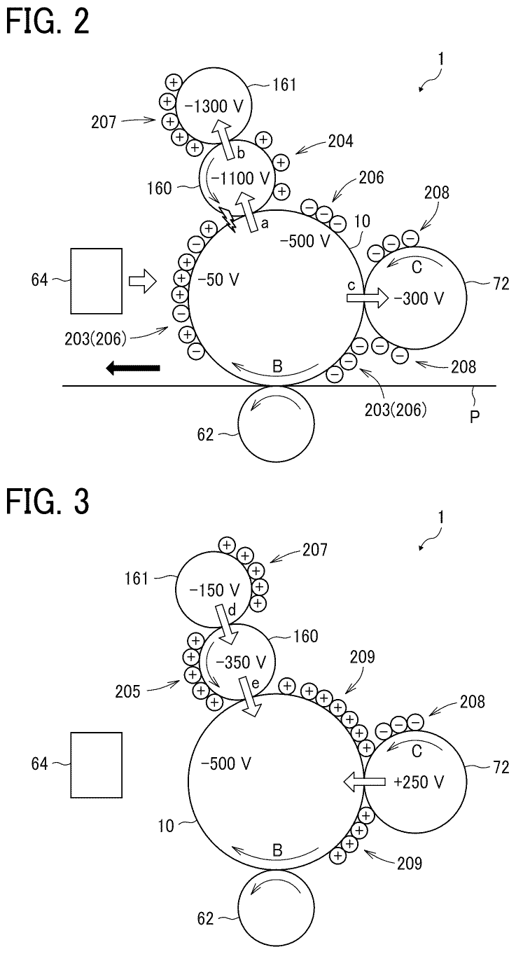

Referring to FIGS. 2 to 4, a description is provided of one example of a method for collecting the residual toner failed to be transferred onto the sheet P, that is performed by the process cartridge 7 according to the embodiment.

FIG. 2 is a schematic diagram of the image forming apparatus 1, illustrating one example of processes performed by the image forming apparatus 1 in a printing period (e.g., an image forming period or an image printing period). For example, the printing period includes a period of exposure for printing and a period from start of exposure for printing until transfer of the toner image. Hence, the printing period includes a process for preparing transfer of the toner image onto the sheet P serving as the recording medium and a process for transferring the toner image onto the sheet P, for example. Printing includes formation of images that are not limited to characters and include symbols, pictures, and patterns.

As illustrated in FIG. 2, toner failed to be transferred onto the sheet P in a transfer process remains on the photoconductive drum 10 as residual toner 203. FIG. 2 illustrates the residual toner 203 that remains on the photoconductive drum 10 at a position downstream from the transfer roller 62 and upstream from the charging roller 160 in the rotation direction B of the photoconductive drum 10.

The image forming apparatus 1 further includes a discharge lamp 64. After the transfer roller 62 transfers a toner image on a previous sheet P, the discharge lamp 64 discharges the surface of the photoconductive drum 10. Accordingly, an electric potential difference between the charging roller 160 and the photoconductive drum 10 increases, generating an electric discharge between the charging roller 160 and the photoconductive drum 10 before the charging roller 160 charges the surface of the photoconductive drum 10. FIG. 2 schematically illustrates the electric discharge.

The electric discharge before charging the photoconductive drum 10 charges the residual toner 203 negatively. For example, the electric discharge before charging the photoconductive drum 10 generates the residual toner 203 that is charged negatively and the residual toner 203 that remains charged slightly positively. The residual toner 203 remaining charged slightly positively adheres to the charging roller 160 by the electric potential difference between the photoconductive drum 10 and the charging roller 160 at a contact position where the charging roller 160 contacts the photoconductive drum 10 or a position in proximity to the contact position. FIG. 2 illustrates toner adhered to the charging roller 160 as toner 204.

FIG. 2 schematically illustrates a direction a in which the residual toner 203 on the photoconductive drum 10 adheres to the charging roller 160. The residual toner 203 on the photoconductive drum 10, that adheres to the charging roller 160, is also referred to as the residual toner 203 that moves to the charging roller 160, for example.

The image forming apparatus 1 according to the embodiment incorporates the brush roller 161 that collects the toner 204 adhered to the charging roller 160. The brush roller 161 collects the toner 204 that is charged positively and is adhered to the charging roller 160. FIG. 2 schematically illustrates a direction b in which the brush roller 161 collects the toner 204 on the charging roller 160. The toner 204 on the charging roller 160, that is collected by the brush roller 161, is also referred to as the toner 204 that moves to the brush roller 161, for example.

The brush roller 161 is applied with a collection bias. The collection bias has a value that is not limited and is selected properly.

The residual toner 203 on the photoconductive drum 10 includes negatively charged toner that does not adhere to the charging roller 160 and remains on the photoconductive drum 10. FIG. 2 illustrates the negatively charged toner as toner 206. The residual toner 203 and the toner 206 are residual toners that are failed to be transferred onto the sheet P and therefore remain on the photoconductive drum 10.

The developing roller 72 collects the toner 206 remaining on the photoconductive drum 10. FIG. 2 illustrates toner collected by the developing roller 72 as toner 208. The toner 208 collected by the developing roller 72 is also referred to as the toner 208 that moves to the developing roller 72, for example. The toner 206 passing through the developing nip N2 formed between the photoconductive drum 10 and the developing roller 72 moves to the developing roller 72 by an electric potential difference between the photoconductive drum 10 and the developing roller 72. FIG. 2 schematically illustrates a direction c in which the developing roller 72 collects the toner 206 on the photoconductive drum 10.

The developing roller 72 employs a method for collecting the toner 206 as described above, that is not limited. For example, the developing roller 72 may employ a method for adjusting an electric potential of each of the components. As one example, the surface of the photoconductive drum 10 after discharging has an electric potential of −50 V. The charging roller 160 has an electric potential of −1,100 V. The brush roller 161 has an electric potential of −1,300 V. The surface of the photoconductive drum 10 after charging has an electric potential of −500 V. The developing roller 72 has an electric potential of −300 V. FIG. 2 illustrates the electric potentials according to the one example, that are not limited.

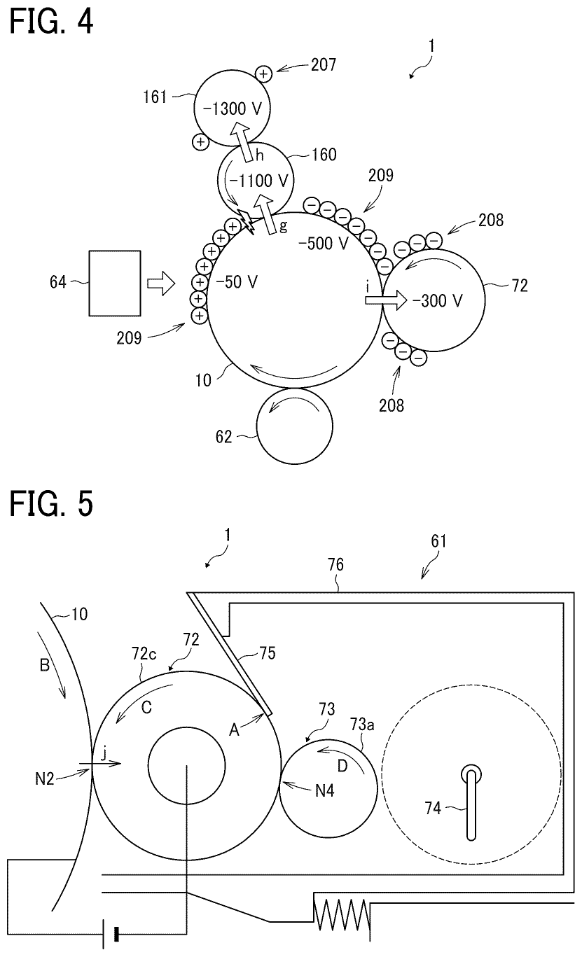

Referring to FIGS. 3 and 4, a description is provided of one example of motion and collection of toner in an idle period of the image forming apparatus 1.

The idle period defines a part of a non-printing period described below. In the idle period, the image forming apparatus 1 performs a predetermined operation after printing (e.g., image formation).

As described above with reference to FIG. 2, the positively charged, residual toner 203 (e.g., the toner 206 also), that is not negatively charged during the electric discharge before the charging roller 160 charges the surface of the photoconductive drum 10, adheres to the charging roller 160 and is collected by the brush roller 161. The brush roller 161 collects the positively charged, residual toner 203 repeatedly as toner 207 in the printing period. The positively charged toner 207 accumulates on the brush roller 161.

As illustrated in FIG. 3, in the idle period, the controller 25 adjusts an electric potential difference between the brush roller 161 and the charging roller 160, moving the toner 207 charged slightly positively to the charging roller 160 in a direction d in FIG. 3.

The toner 205 moved to the charging roller 160 moves to the photoconductive drum 10 by the electric potential difference between the charging roller 160 and the photoconductive drum 10 in a direction e in FIG. 3. FIG. 3 illustrates toner moved onto the photoconductive drum 10 as toner 209. In the idle period, the discharge lamp 64 does not discharge the photoconductive drum 10. Hence, the controller 25 adjusts the electric potential difference between the charging roller 160 and the photoconductive drum 10 in view of the discharge lamp 64 that does not discharge the photoconductive drum 10.

The positively charged toner 209 on the photoconductive drum 10 is not collected by the developing roller 72 and passes through the developing nip N2 formed between the photoconductive drum 10 and the developing roller 72. The toner 209 passes through the transfer nip N3 formed between the photoconductive drum 10 and the transfer roller 62. Thus, in the idle period, the positively charged toner 209 remains on the photoconductive drum 10.

FIGS. 2, 3, and 4 illustrate the residual toner 203, the toner 206, and the toner 209 that adhere to the photoconductive drum 10 and define residual toners failed to be transferred onto the sheet P and therefore remaining on the photoconductive drum 10. After the brush roller 161 collects the residual toner 203, the residual toner 203 returns to the photoconductive drum 10 as the toner 209 that defines the residual toner.

FIG. 3 illustrates a method for moving toner, that is not limited. For example, the image forming apparatus 1 may employ a method for adjusting an electric potential of each of the components. For example, the brush roller 161 has an electric potential of −150 V. The charging roller 160 has an electric potential of −350 V. The surface of the photoconductive drum 10 has an electric potential of −500 V. The developing roller 72 has an electric potential of +250 V. FIG. 3 illustrates the electric potentials according to the one example, that are not limited.

Referring to FIG. 4, a description is provided of collection of toner on the photoconductive drum 10 in the idle period.

FIG. 4 illustrates a state of the image forming apparatus 1 after a state of the image forming apparatus 1 depicted in FIG. 3.

As illustrated in FIG. 4, the discharge lamp 64 discharges the photoconductive drum 10 at a predetermined time. Accordingly, the electric potential difference between the charging roller 160 and the photoconductive drum 10 increases, generating an electric discharge between the charging roller 160 and the photoconductive drum 10. FIG. 4 schematically illustrates the electric discharge. The discharge lamp 64 discharges the photoconductive drum 10 not for image formation but for collection of toner.

The electric discharge charges the toner 209 negatively. Like in FIG. 2, the toner 209 includes toner that is not charged negatively and remains being charged positively. The positively charged toner moves and adheres to the charging roller 160 in a direction g. Thereafter, the positively charged toner moves in a direction h and is collected by the brush roller 161.

The toner 209 charged negatively by the electric discharge described above does not move to the charging roller 160 and remains on the photoconductive drum 10. The negatively charged toner 209 moves in a direction i and is collected by the developing roller 72 applied with the developing bias. FIG. 4 illustrates toner collected by the developing roller 72 as the toner 208.

FIG. 4 illustrates a method for moving toner, that is not limited. For example, the image forming apparatus 1 may employ a method for adjusting an electric potential of each of the components. For example, the brush roller 161 has an electric potential of −1,300 V. The charging roller 160 has an electric potential of −1,100 V. The surface of the photoconductive drum 10 after discharging has an electric potential of −50 V. The surface of the photoconductive drum 10 has an electric potential of −500 V. The developing roller 72 has an electric potential of −300 V. FIG. 4 illustrates the electric potentials according to the one example, that are not limited.

As described above, the brush roller 161 uses the electric potential difference and mechanically scrapes the positively charged toner adhered to the charging roller 160, thus removing the toner from the charging roller 160.

For example, the controller 25 depicted in FIG. 1 adjusts the electric potential of the components. Specifically, the controller 25 controls the power supplies such as the charging power supply 21 to adjust the electric potential of the photoconductive drum 10, the transfer roller 62, the developing roller 72, the charging roller 160, the brush roller 161, and the like. The controller 25 includes a central processing unit (CPU). FIG. 1 illustrates the controller 25. FIG. 2 and the like omit illustration of the controller 25.

The image forming apparatus 1 according to the embodiment employs a cleanerless system as described above. The cleanerless system controls a charging property of toner and uses an electric field in each process to move and collect the toner. Thus, the cleanerless system prevents the toner from staining the charging roller 160 and the brush roller 161. Additionally, the cleanerless system does not generate waste toner, eliminating a waste toner container, reducing waste, and simplifying user maintenance advantageously.

Referring to FIG. 5, a description is provided of a construction of the developing device 61 in detail.

As illustrated in FIG. 5, the developing device 61 includes the developing roller 72 serving as a developer bearer, a supply roller 73 serving as a supply rotator, an agitator 74, a regulation blade 75 serving as a layer thickness regulator, and a developer container 76.

As the agitator 74 rotates, the agitator 74 agitates toner inside the developer container 76 and supplies the toner to the supply roller 73.

The supply roller 73 rotates in a rotation direction D. The supply roller 73 contacts the developing roller 72 to form a supply nip N4 therebetween. At the supply nip N4, the supply roller 73 supplies the toner from a surface of the supply roller 73 to the developing roller 72. As the developing roller 72 rotates in a rotation direction C, the developing roller 72 supplies the toner to the photoconductive drum 10, developing an electrostatic latent image formed on the photoconductive drum 10.

The regulation blade 75 is disposed downstream from the supply nip N4 and disposed upstream from the developing nip N2 in the rotation direction C of the developing roller 72. The regulation blade 75 contacts a surface (e.g., an outer circumferential face 72c) of the developing roller 72 to regulate a layer thickness of the developer on the surface of the developing roller 72. For example, the regulation blade 75 decreases the layer thickness of the developer.

As described above with reference to FIGS. 2 to 4, in the printing period and the idle period, the residual toner that is negatively charged moves from the photoconductive drum 10 to the developing roller 72 in a direction j in FIG. 5. The foreign substance such as paper dust also moves from the photoconductive drum 10 to the developing roller 72, thus being collected by the developing roller 72 of the developing device 61 together with the residual toner. The developing roller 72 and the regulation blade 75 may sandwich the foreign substance collected by the developing roller 72 at a gap A between the developing roller 72 and the regulation blade 75 depicted in FIG. 5, for example. The foreign substance may stick to the regulation blade 75, causing the regulation blade 75 to perform faulty regulation of the layer thickness of toner on the surface of the developing roller 72. Accordingly, a faulty image having vertical streaks or the like may be formed on the sheet P.

A description is provided of a construction of a first comparative image forming apparatus.

The first comparative image forming apparatus includes a photoconductor, a developing roll, and a layer forming blade. The developing roll includes projections and recesses that are arranged on a surface of the developing roll alternately in an axial direction of the developing roll. The projection has a height in a range of from 3 μm to 12 μm. The projections and the recesses decrease a contact area in which the developing roll contacts the photoconductor and the layer forming blade. Accordingly, as the developing roll physically presses against the photoconductor and the layer forming blade, the projections and the recesses of the developing roll prevent toner from melting and sticking to the photoconductor and the layer forming blade.

A description is provided of a construction of a second comparative image forming apparatus.

The second comparative image forming apparatus includes a latent image bearer and a developing device and does not include a cleaner that removes residual toner (e.g., a residual developer) that is failed to be transferred and therefore remains on the latent image bearer. The developing device includes a developer bearer that collects the residual toner from the latent image bearer for reuse.

The latent image bearer contacts the developer bearer to form a nip therebetween. At the nip, in addition to the residual developer failed to be transferred and remaining on the latent image bearer, a foreign substance such as paper dust also moves to the developer bearer.

The developer bearer bears a developer layer on a surface of the developer bearer. The developing device further includes a layer thickness regulator that contacts the developer bearer and regulates a thickness of the developer layer. The foreign substance may move to a gap between the developer bearer and the layer thickness regulator or to the layer thickness regulator. Accordingly, the layer thickness regulator may suffer from a failure in layer thickness regulation with respect to the developer bearer, forming a faulty toner image on a recording medium.

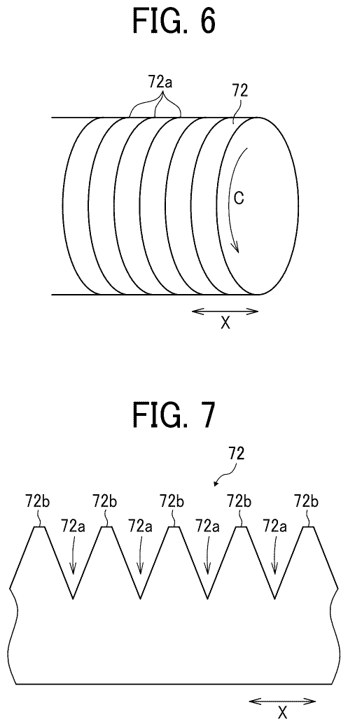

To address the above-described circumstances, according to the embodiment, the outer circumferential face 72c of the developing roller 72 has a maximum height roughness Rz in an axial direction of the developing roller 72, that is greater than 5.5 μm, and an arithmetic average roughness Ra in a circumferential direction of the developing roller 72, that is smaller than 1.0 μm. The outer circumferential face 72c of the developing roller 72 has a hardness that is not smaller than 50. FIG. 6 illustrates an axial direction X of the developing roller 72, that is perpendicular to a paper surface in FIG. 5. The circumferential direction of the developing roller 72 follows the rotation direction C of the developing roller 72 on a hypothetical plane perpendicular to the axial direction X of the developing roller 72. FIG. 5 illustrates the outer circumferential face 72c of the developing roller 72 with a circle of the developing roller 72 as an edge of the developing roller 72 in a radial direction thereof.

The surface roughness of the developing roller 72 was measured with a surface roughness tester SURFCOM 1400D available from Tokyo Seimitsu Co., Ltd., that conforms to the Japanese Industrial Standards (JIS) B0601-2001 under the following conditions.
Measurement length L: 4.0 mm
Reference length Lr: 0.8 mm
Cutoff wavelength λc: 0.8 mm
Shape of tip of stylus: cone with tip angle of 60 degrees
Diameter of tip of stylus: 2 μm
Measurement speed: 0.3 mm/sec
Measurement magnification: 10,000× magnification

The maximum height roughness Rz was measured in the axial direction X of the developing roller 72 at four positions that were spaced at 90-degree intervals around a circumference of the developing roller 72 in the circumferential direction thereof, thus calculating an average of the measured maximum height roughnesses Rz. The arithmetic average roughness Ra was measured in the circumferential direction of the developing roller 72 at five positions that were arranged on the developing roller 72 in the axial direction X thereof, thus calculating an average of the measured arithmetic average roughnesses Ra. The five positions included a center position, one lateral end position, another lateral end position, one intermediate position between the center position and the one lateral end position, and another intermediate position between the center position and the another lateral end position in the axial direction X of the developing roller 72.

As described above, according to the embodiment, the maximum height roughness Rz in the axial direction X of the developing roller 72 was obtained by calculating a difference in height between a recess and a projection in the axial direction X of the developing roller 72 at predetermined positions on the outer circumferential face 72c of the developing roller 72 serving as the developer bearer, that were arranged in the circumferential direction thereof and calculating an average of the calculated differences. The arithmetic average roughness Ra on the outer circumferential face 72c of the developing roller 72 in the circumferential direction thereof was obtained by calculating an average roughness between the recess and the projection in the circumferential direction of the developing roller 72 at predetermined positions on the outer circumferential face 72c of the developing roller 72 serving as the developer bearer, that were arranged in the axial direction X thereof and calculating an average of the calculated average roughnesses.

The hardness of the developing roller 72 serving as the developer bearer defines micro rubber hardness. The hardness of the developing roller 72 was measured with a micro rubber hardness tester Asker MD-1 available from Kobunshi Keiki Co., Ltd. at four positions that were spaced at 90-degree intervals around the circumference of the developing roller 72 in the circumferential direction thereof and were arranged at three positions in the axial direction X of the developing roller 72, thus calculating an average of the measured hardnesses. The three positions included a center position and both lateral end positions in the axial direction X of the developing roller 72. Thus, the hardness of the developing roller 72 was measured at twelve positions totally.

Referring to FIGS. 6 and 7, a description is provided of a construction of the developing roller 72 according to the embodiment, that has preset values calculated as described above.

FIG. 6 is a partial perspective view of the developing roller 72. FIG. 7 is a cross-sectional view of the surface of the developing roller 72 in the axial direction X thereof.

As illustrated in FIGS. 6 and 7, the developing roller 72 according to the embodiment includes a plurality of grooves 72a disposed on the surface (e.g., the outer circumferential face 72c) of the developing roller 72. Each of the grooves 72a extends in the circumferential direction of the developing roller 72. The grooves 72a are arranged in the axial direction X of the developing roller 72. According to the embodiment, multiple pairs of a projection and a recess are arranged in the axial direction X of the developing roller 72, increasing the maximum height roughness Rz in the axial direction X. Each of the projection and the recess extends around the circumference of the developing roller 72 in the circumferential direction thereof, decreasing the arithmetic average roughness Ra in the circumferential direction of the developing roller 72.

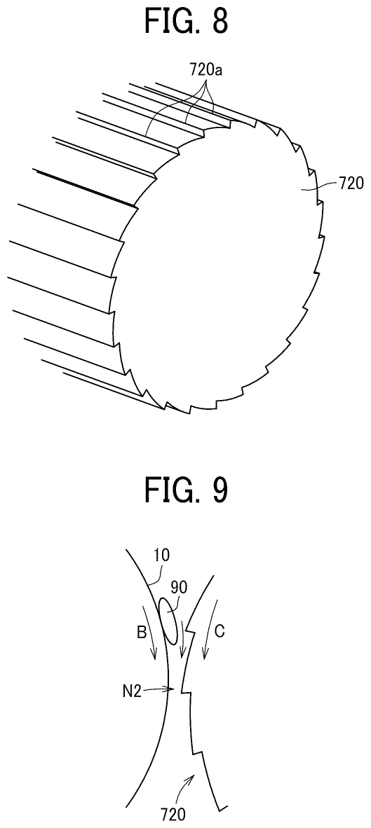

FIG. 8 is a perspective view of a developing roller 720 having a construction that is different from the construction of the developing roller 72.

As illustrated in FIG. 8, the developing roller 720 includes a plurality of steps 720a disposed on an outer circumferential face of the developing roller 720. The steps 720a are arranged in a circumferential direction of the developing roller 720. The developing roller 720 has a shape that is substantially uniform in an axial direction of the developing roller 720.

As illustrated in FIG. 8, the developing roller 720 is substantially even in the axial direction thereof. Hence, as illustrated in FIG. 9, as the photoconductive drum 10 rotates in the rotation direction B, the photoconductive drum 10 conveys a foreign substance 90 on the surface of the photoconductive drum 10 to the developing nip N2. Accordingly, a surface of the developing roller 720 may contact the foreign substance 90, moving the foreign substance 90 from the photoconductive drum 10 to the surface of the developing roller 720 easily.

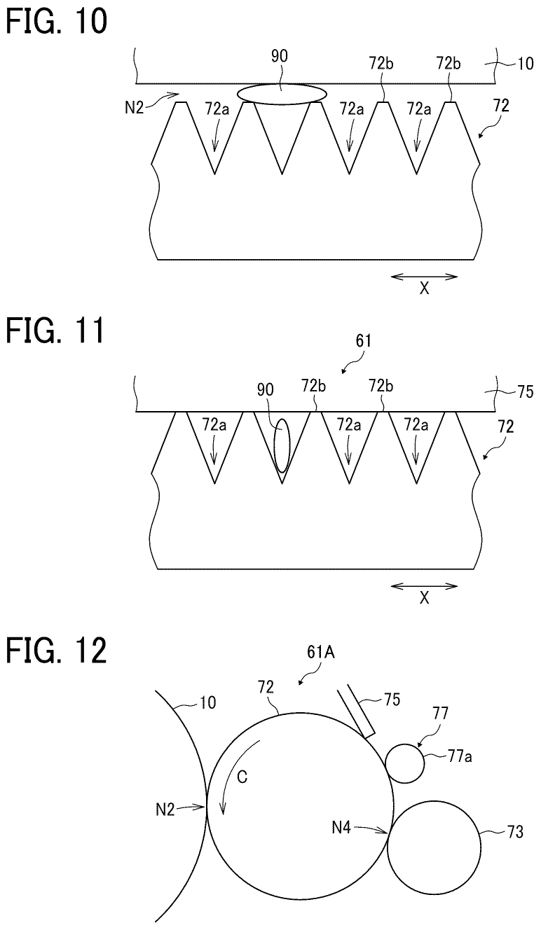

To address the circumstance, the developing roller 72 according to the embodiment depicted in FIG. 7 includes the plurality of grooves 72a and a plurality of projections 72b. The grooves 72a are arranged in the axial direction X of the developing roller 72. The projection 72b is interposed between the adjacent grooves 72a. The grooves 72a decrease a length and an area of the projection 72b in the axial direction X of the developing roller 72. Accordingly, as illustrated in FIG. 10, the projections 72b decrease a contact area where the developing roller 72 contacts the foreign substance 90 on the surface of the photoconductive drum 10, preventing the foreign substance 90 from moving from the photoconductive drum 10 to the surface of the developing roller 72. A direction perpendicular to a paper surface in FIG. 10 defines the rotation direction B of the photoconductive drum 10 and the rotation direction C of the developing roller 72 depicted in FIG. 10 at the developing nip N2.

As the developing roller 72 has decreased irregularities in the circumferential direction thereof, that is, as the arithmetic average roughness Ra in the circumferential direction of the developing roller 72 decreases, the developing roller 72 has a shape that is even in the circumferential direction thereof. According to the embodiment, the developing roller 72 has a shape constructed of a plurality of regions, each of which is defined by the groove 72a and the projection 72b that are alternately arranged in the axial direction X of the developing roller 72. The shape of the developing roller 72 extends in the circumferential direction of the developing roller 72. Accordingly, compared to a construction in which irregularities are scattered on a surface of a developing roller, the developing roller 72 depicted in FIG. 10 contacts the foreign substance 90 at the projections 72b, decreasing the contact area where the developing roller 72 contacts the foreign substance 90. Additionally, the foreign substance 90 enters the groove 72a.

As described above, the grooves 72a and the projections 72b reduce the foreign substance 90 that moves from the photoconductive drum 10 to the developing roller 72, preventing the foreign substance 90 from being sandwiched between the developing roller 72 and the regulation blade 75 and moving to the regulation blade 75. Even in a case that the foreign substance 90 moves from the photoconductive drum 10 to the developing roller 72, the foreign substance 90 enters the groove 72a of the developing roller 72, reducing the foreign substance 90 that moves from the developing roller 72 to a surface of the regulation blade 75. For example, as illustrated in FIG. 11, as the developing roller 72 contacts the regulation blade 75, the foreign substance 90 captured within the groove 72a does not protrude beyond the surface of the developing roller 72. Conversely, with the developing roller 720 depicted in FIG. 8, the foreign substance moved from the photoconductive drum 10 to the developing roller 720 adheres to the developing roller 720 in a state in which the foreign substance protrudes beyond the surface of the developing roller 720. With the developing roller 72 according to the embodiment, the foreign substance 90 captured within the groove 72a of the developing roller 72 does not move to the regulation blade 75 easily. Hence, the developing roller 72 and the regulation blade 75 do not sandwich the foreign substance 90. The developing roller 72 reduces the foreign substance 90 that moves to the regulation blade 75.

In a case that the developing roller 72 has an insufficient hardness, as the developing roller 72 is pressed against the photoconductive drum 10 at the developing nip N2, the photoconductive drum 10 may press and flatten the surface of the developing roller 72, increasing a contact area where the developing roller 72 contacts the photoconductive drum 10. Accordingly, the foreign substance 90 in an increased amount may move from the photoconductive drum 10 to the developing roller 72. To address the circumstance, the developing roller 72 according to the embodiment has the hardness not smaller than 50, suppressing deformation of the developing roller 72 at the developing nip N2 and reducing the foreign substance 90 that moves from the photoconductive drum 10 to the developing roller 72.

The developing roller 72 has a portion including the outer circumferential face 72c, that is preferably made of an elastic material, for example, rubber, thus ensuring an area of the developing nip N2, that is not smaller than a predetermined area. Accordingly, the developing roller 72 reduces the foreign substance 90 that moves from the photoconductive drum 10 to the developing roller 72 as described above. Additionally, the developing roller 72 supplies toner to the photoconductive drum 10, developing an electrostatic latent image formed on the photoconductive drum 10 properly.

The supply roller 73 has an enhanced scraping capability to scrape the foreign substance 90 from the developing roller 72, reducing the foreign substance 90 that is sandwiched between the developing roller 72 and the regulation blade 75 and the foreign substance 90 that moves to the regulation blade 75. For example, the supply roller 73 has an enhanced hardness that improves the scraping capability to scrape the foreign substance 90 from the surface of the developing roller 72 at the supply nip N4. Specifically, an outer circumferential face 73a of the supply roller 73 preferably has a 1.5 mm indentation load not smaller than 4 N. Thus, the supply roller 73 attains a sufficient scraping capability to scrape the foreign substance 90 from the developing roller 72.

The indentation load of the supply roller 73 was measured with a spring tester PRO-1N available from Japan Instrumentation System Co., Ltd., that conforms to JIS B7738. Both lateral ends of the supply roller 73 in an axial direction thereof were secured using a V-block such that the surface of the supply roller 73 extended horizontally. A compression plate pressed against the outer circumferential face 73a of the supply roller 73 at 1.5 mm depth to measure the indentation load [N]. Measurement was performed at three spots in the axial direction of the supply roller 73 and two spots in a circumferential direction of the supply roller 73, that is, at six spots totally. Measurement values were averaged to obtain the indentation load on the outer circumferential face 73a of the supply roller 73. The axial direction of the supply roller 73 is parallel to the axial direction X of the developing roller 72 and is perpendicular to the paper surface in FIG. 5.

The outer circumferential face 73a of the supply roller 73 is preferably made of a foam material. Accordingly, the supply roller 73 has cells that capture the foreign substance 90. The cells provide space through which toner in an increased amount is conveyed. Thus, the supply roller 73 improves the scraping capability to scrape the foreign substance 90 from the developing roller 72 and the supply capability to supply toner to the developing roller 72.

FIG. 12 illustrates a developing device 61A that includes a removal roller 77 that removes the foreign substance 90 from the surface of the developing roller 72. For example, the developing device 61A depicted in FIG. 12 incorporates the removal roller 77 that is disposed downstream from the supply nip N4 and disposed upstream from an opposed position where the regulation blade 75 is disposed opposite the developing roller 72 in the rotation direction C thereof. The removal roller 77 contacts the developing roller 72. The removal roller 77 removes the foreign substance 90 from the surface of the developing roller 72. Thus, the removal roller 77 preferably reduces the foreign substance 90 that is sandwiched between the developing roller 72 and the regulation blade 75 and the foreign substance 90 that moves to the regulation blade 75. Alternatively, the removal roller 77 may be disposed downstream from the developing nip N2 and disposed upstream from the supply nip N4 in the rotation direction C of the developing roller 72.

The removal roller 77 preferably has a 1.5 mm indentation load not smaller than 4 N. Thus, the removal roller 77 attains a sufficient scraping capability to scrape the foreign substance 90 from the developing roller 72. The removal roller 77 has an outer circumferential face 77a that is preferably made of a foam material. Thus, the removal roller 77 improves the scraping capability to scrape the foreign substance 90 from the developing roller 72.

As described above, the supply roller 73 improves the scraping capability to scrape the foreign substance 90 from the developing roller 72. Hence, compared to a configuration in which the developing device 61A incorporates the removal roller 77, the supply roller 73 reduces a number of parts of the developing device 61 and decreases costs of the developing device 61. Conversely, in the developing device 61A incorporating the removal roller 77 separately from the supply roller 73, the supply roller 73 has a soft surface, for example, to enhance the supply capability to supply toner to the developing roller 72. The removal roller 77 removes the foreign substance 90 efficiently. Thus, the supply roller 73 and the removal roller 77 are specialized for respective functions.

A description is provided of results of an experiment that examines prevention of white streaks that appear on a toner image formed on a sheet in an image forming apparatus employing a developing device including a developing roller (e.g., the developing roller 72) and a supply roller (e.g., the supply roller 73).

The experiment used developing rollers and supply rollers according to embodiments 1 and 2 and comparative examples 1, 2, and 3 depicted in Table 1 below. The developing rollers according to the embodiments 1 and 2 had the maximum height roughness Rz that was greater than 5.5 μm, the arithmetic average roughness Ra that was smaller than 1.0 μm, and the hardness that was greater than 50. Conversely, the developing rollers according to the comparative examples 1, 2, and 3 had at least one of the maximum height roughness Rz, the arithmetic average roughness Ra, or the hardness, that did not satisfy the reference value described above. The supply roller according to the embodiment 1 had the 1.5 mm indentation load that was superior to the 1.5 mm indentation load of the supply roller according to the embodiment 2.

TABLE 1

| | Developing roller | | Supply roller | |
|---|---|---|---|---|
| | Rz [μm] | Ra [μm] | Hardness | Indentation load [N] |
| Embodiment 1 | 7.0 | 0.8 | 55.0 | 5.0 |
| Embodiment 2 | 7.0 | 0.8 | 55.0 | 3.0 |
| Comparative | 4.0 | 0.9 | 57.0 | 5.0 |
| example 1 | | | | |
| Comparative | 6.8 | 1.2 | 56.0 | 5.0 |
| example 2 | | | | |
| Comparative | 6.2 | 0.7 | 40.0 | 5.0 |
| example 3 | | | | |

In the experiment, the developing roller and the supply roller were installed in the image forming apparatus prepared by modifying the printer P501 available from Ricoh Co., Ltd. into a cleanerless printer. The image forming apparatus printed a 2% image chart on 20,000 sheets conveyed intermittently one by one. The experiment used ASKUL Super White+ sheets available from ASKUL Corporation and examined whether or not white streaks appeared on a toner image formed on a sheet.

According to the embodiment 1, when the image forming apparatus printed 20,000 sheets, no white streaks appeared on the sheets. According to the embodiment 2, when the image forming apparatus printed 15,000 to 20,000 sheets, white streaks appeared on a toner image initially. According to the comparative examples 1, 2, and 3, when the image forming apparatus printed sheets less than 15,000 sheets, white streaks appeared on a toner image. In a developing device that generated the white streaks, an opposed portion of a regulation blade, that was disposed opposite the developing roller, caught paper dust. Conversely, according to the embodiment 1, the opposed portion of the regulation blade did not catch paper dust. The embodiments 1 and 2 achieved proper results. For example, the embodiment 1 that did not generate white streaks even when the image forming apparatus printed 20,000 sheets achieved superior results. The comparative examples 1, 2, and 3 had unacceptable results.

The experiment indicates that the embodiments 1 and 2 suppress white streaks compared to the comparative examples 1, 2, and 3. The embodiments 1 and 2 satisfy three conditions of the developing roller, that is, the maximum height roughness Rz greater than 5.5 μm, the arithmetic average roughness Ra smaller than 1.0 μm, and the hardness not smaller than 50. Under the three conditions of the developing roller, the developing roller reduces the foreign substance 90 that is sandwiched between the developing roller and the regulation blade and the foreign substance 90 that moves to the regulation blade. Comparison between the embodiments 1 and 2 indicates that the supply roller having the indentation load that is not smaller than 4 N removes the foreign substance 90 more effectively.

The above describes the embodiments of the present disclosure. However, the technology of the present disclosure is not limited to the embodiments described above and is modified within the scope of the present disclosure.

Application of the technology of the present disclosure is not limited to the monochrome image forming apparatus 1 depicted in FIG. 1 that forms a monochrome toner image. The technology of the present disclosure is also applied to a color image forming apparatus that forms a color toner image, a copier, a printer, a facsimile machine, a multifunction peripheral (MFP) having at least two of copying, printing, facsimile, scanning, and plotter functions, or the like.

In addition to plain paper as the sheet P, the recording media include thick paper, a postcard, an envelope, thin paper, coated paper, art paper, tracing paper, an overhead projector (OHP) transparency, plastic film, a prepreg sheet, and copper foil.

A description is provided of aspects of the embodiments of the present disclosure, for example.

A description is provided of a first aspect of the present disclosure.

A developer bearer (e.g., the developing roller 72) is rotatable and bears a developer on a surface of the developer bearer. The developer bearer supplies the developer to a latent image bearer (e.g., the photoconductive drum 10) to develop a latent image formed on a surface of the latent image bearer. The developer bearer is incorporated in a developing device (e.g., the developing devices 61 and 61A).

The developer bearer has an outer circumferential face (e.g., the outer circumferential face 72c) that has a maximum height roughness Rz in an axial direction (e.g., the axial direction X) of the developer bearer. The maximum height roughness Rz is greater than 5.5 μm. The outer circumferential face of the developer bearer has an arithmetic average roughness Ra in a circumferential direction of the developer bearer. The arithmetic average roughness Ra is smaller than 1.0 μm. The outer circumferential face of the developer bearer has a hardness not smaller than 50.

A description is provided of a second aspect of the present disclosure.

The outer circumferential face of the developer bearer according to the first aspect is made of an elastic material.

A description is provided of a third aspect of the present disclosure.

The outer circumferential face of the developer bearer according to the first aspect or the second aspect includes a groove (e.g., the groove 72a) that extends in the circumferential direction of the developer bearer.

A description is provided of a fourth aspect of the present disclosure.

A developing device (e.g., the developing devices 61 and 61A) includes the developer bearer according to any one of the first aspect to the third aspect and a supply rotator (e.g., the supply roller 73) that forms a supply nip (e.g., the supply nip N4) between the developer bearer and the supply rotator. The supply rotator supplies the developer to the developer bearer.

A description is provided of a fifth aspect of the present disclosure.

In the developing device according to the fourth aspect, the supply rotator has an outer circumferential face (e.g., the outer circumferential face 73a) that is made of a foam material.

A description is provided of a sixth aspect of the present disclosure.

In the developing device according to the fourth aspect or the fifth aspect, the outer circumferential face of the supply rotator has a 1.5 mm indentation load that is not smaller than 4 N.

A description is provided of a seventh aspect of the present disclosure.

The developing device according to any one of the fourth aspect to the sixth aspect further includes a removal roller (e.g., the removal roller 77) that is rotatable. The removal roller contacts the outer circumferential face of the developer bearer and removes a foreign substance therefrom.

A description is provided of an eighth aspect of the present disclosure.

In the developing device according to the seventh aspect, the removal roller has an outer circumferential face (e.g., the outer circumferential face 77a) that is made of a foam material.

A description is provided of a ninth aspect of the present disclosure.

In the developing device according to the seventh aspect or the eighth aspect, the outer circumferential face of the removal roller has a 1.5 mm indentation load that is not smaller than 4 N.

A description is provided of a tenth aspect of the present disclosure.

A process cartridge (e.g., the process cartridge 7) includes the developing device according to any one of the fourth aspect to the ninth aspect and the latent image bearer. The process cartridge does not include a cleaner that removes a residual developer remaining on the surface of the latent image bearer therefrom. The developing device of the process cartridge reuses the residual developer.

A description is provided of an eleventh aspect of the present disclosure.

An image forming apparatus (e.g., the image forming apparatus 1) includes the developing device according to any one of the fourth aspect to the ninth aspect or the process cartridge according to the tenth aspect.

Accordingly, the developer bearer, the developing device, the process cartridge, and the image forming apparatus reduce the foreign substance that moves to a layer thickness regulator (e.g., the regulation blade 75).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A developing device comprising:
a developer bearer to rotate, the developer bearer to bear a developer; and
a layer thickness regulator to regulate a thickness of the developer on the developer bearer,
the developer bearer having an outer circumferential face having:
a maximum height roughness Rz in an axial direction of the developer bearer, the maximum height roughness Rz being greater than 5.5 μm;
an arithmetic average roughness Ra in a circumferential direction of the developer bearer, the arithmetic average roughness Ra being smaller than 1.0 μm; and
a hardness being not smaller than 50.

2. The developing device according to claim 1,
wherein the outer circumferential face of the developer bearer includes an elastic material.

3. The developing device according to claim 1,
wherein the outer circumferential face of the developer bearer includes a groove that extends in the circumferential direction of the developer bearer.

4. The developing device according to claim 3,
wherein the outer circumferential face of the developer bearer further includes a projection arranged with the groove in the axial direction of the developer bearer.

5. The developing device according to claim 4,
wherein the groove captures a foreign substance within the groove, and
wherein the projection contacts another foreign substance.

6. The developing device according to claim 1, further comprising a supply rotator to form a supply nip between the developer bearer and the supply rotator, the supply rotator to supply the developer to the developer bearer.

7. The developing device according to claim 6,
wherein the supply rotator has an outer circumferential face that includes a foam material.

8. The developing device according to claim 6,
wherein the outer circumferential face of the supply rotator has a 1.5 mm indentation load that is not smaller than 4 N.

9. The developing device according to claim 6,
wherein the supply rotator includes a supply roller.

10. The developing device according to claim 6, further comprising a removal roller to rotate, the removal roller contacting the outer circumferential face of the developer bearer, the removal roller to remove a foreign substance from the outer circumferential face of the developer bearer.

11. The developing device according to claim 10,
wherein the removal roller has an outer circumferential face that includes a foam material.

12. The developing device according to claim 1,
wherein the developer bearer includes a developing roller, and
wherein the layer thickness regulator includes a regulation blade.

13. A process cartridge comprising:
a latent image bearer to bear a latent image and a developer remaining on the latent image bearer; and
a developing device to reuse the developer,
the developing device including:
a developer bearer to rotate, the developer bearer to bear the developer and supply the developer to the latent image bearer to develop the latent image; and
a layer thickness regulator to regulate a thickness of the developer on the developer bearer,
the developer bearer having an outer circumferential face having:
a maximum height roughness Rz in an axial direction of the developer bearer, the maximum height roughness Rz being greater than 5.5 μm;
an arithmetic average roughness Ra in a circumferential direction of the developer bearer, the arithmetic average roughness Ra being smaller than 1.0 μm; and
a hardness being not smaller than 50.

14. The process cartridge according to claim 13,
wherein the latent image bearer includes a photoconductive drum.

15. An image forming apparatus comprising:
a process cartridge; and
a transfer device disposed opposite the process cartridge,
the process cartridge including:
a latent image bearer to bear a latent image and a developer remaining on the latent image bearer; and
a developing device to reuse the developer,
the developing device including:
a developer bearer to rotate, the developer bearer to bear the developer and supply the developer to the latent image bearer to develop the latent image; and
a layer thickness regulator to regulate a thickness of the developer on the developer bearer,
the developer bearer having an outer circumferential face having:
a maximum height roughness Rz in an axial direction of the developer bearer, the maximum height roughness Rz being greater than 5.5 μm;
an arithmetic average roughness Ra in a circumferential direction of the developer bearer, the arithmetic average roughness Ra being smaller than 1.0 μm; and
a hardness being not smaller than 50.
